(19) United States
(12) Patent Application Publication
(10) Pub. No.: US 2025/0304033 A1
(43) Pub. Date: Oct. 2, 2025

(54) METHOD FOR IMPROVING A VEHICLE-DYNAMICS-RELATED STABILITY OF A UTILITY VEHICLE HAVING A LIFT AXLE

(71) Applicant: ZF CV Systems Global GmbH, Bern (CH)

(72) Inventors: Benjamin Bieber, Wedemark (DE); Jonas Böttcher, Hannover (DE); Klaus Plähn, Seelze (DE); Oliver Wulf, Neustadt (DE)

(21) Appl. No.: 19/235,471

(22) Filed: Jun. 11, 2025

Related U.S. Application Data
(63) Continuation of application No. PCT/EP2023/083324, filed on Nov. 28, 2023.

(30) Foreign Application Priority Data
Dec. 20, 2022 (DE) 10 2022 134 146.1

(51) Int. Cl. B60W 30/02; B60W 50/00; B62D 12/02; B62D 61/12

(52) U.S. Cl. CPC B60W 30/02; B60W 50/0097; B62D 12/02; B62D 61/12; B60W 2520/10; B60W 2520/28; B60W 2530/10; B60W 2710/20

(57) ABSTRACT

A method is for improving a vehicle-dynamics-related stability of a utility vehicle, wherein the utility vehicle has a lift axle. The method includes: determining a current ground speed of the utility vehicle; determining a stability-critical speed of the utility vehicle; comparing the current ground speed with the stability-critical speed; determining a lift status of the lift axle of the utility vehicle; and lowering the lift axle of the utility vehicle if the lift status represents a raised lift axle and the current ground speed is greater than or equal to the stability-critical speed. A device is for improving a vehicle-dynamics-related stability of a utility vehicle.

### CROSS-REFERENCE TO RELATED APPLICATIONS

This application is a continuation application of international patent application PCT/EP2023/083324, filed Nov. 28, 2023, designating the United States and claiming priority from German application 10 2022 134 146.1, filed Dec. 20, 2022, and the entire content of both applications is incorporated herein by reference.

### TECHNICAL FIELD

The disclosure relates to a method for improving the vehicle-dynamics-related stability of a utility vehicle with a lift axle.

### BACKGROUND

A utility vehicle is a motor vehicle which, due to its configuration and equipment, is intended for the transportation of persons or goods and/or for towing trailers, but is not a passenger car or motorcycle. A utility vehicle is, for example, a bus, a truck, a tractor unit or a crane truck. In the context of the present disclosure, the utility vehicle may be a simple utility vehicle, often referred to as a rigid vehicle, or a vehicle combination including a towing vehicle and one or more trailer vehicles. A typical example of a vehicle combination includes a tractor unit and a semi-trailer.

Utility vehicles are usually configured to transport heavy loads and often have more than two axles in order to distribute the load evenly over the ground and avoid placing too much strain on individual axles. However, auxiliary axles have the disadvantage that they increase the operating costs of the utility vehicle when the auxiliary axles are not required. For example, fuel consumption and wear on the utility vehicle with auxiliary axles is generally increased. Furthermore, auxiliary axles often reduce the maneuverability of the utility vehicle, which can be particularly disadvantageous in urban areas. Utility vehicles often have a liftable auxiliary axle, also known as a lift axle. Such an axle can be raised or lifted, wherein the lift axle does not rest on the road when raised. In the raised state, the wheels of the lift axle do not rotate, which results in particular in economic advantages. Tire wear is reduced, especially when cornering. Furthermore, fuel savings are possible due to reduced bearing and tire friction and tolls can be saved on tariffs that are payable per axle. The turning circle of the utility vehicle is generally smaller with a raised lift axle than with a lowered lift axle. For these reasons, lift axles are usually only lowered if the load to be transported by the utility vehicle is so large that the permissible axle load of the non-lifted axles is exceeded when the lift axle is raised, or if the vehicle exceeds a permissible axle load for driving on a bridge when the lift axle is raised. When the lift axle is lowered, the load of the vehicle is distributed to an auxiliary axle and the axle load of the individual axles is reduced. However, the ability of the utility vehicle to transport larger loads when the lift axle is lowered is associated with greater wear and higher costs for the reasons mentioned above.

In the prior art, the lowering of the lift axle is therefore generally load-dependent. DE 20 2019 003 735 U1 discloses a device for the automatic lowering and load-dependent raising of a lift axle, wherein devices for automatic raising only raise a lowered lift axle when the weight on a loading surface falls below a predeterminable maximum weight.

DE 10 2019 007 532 A1 discloses a method for situation-dependent control of a lift axle of a utility vehicle, in which the lift axle is lowered. In the disclosed method, via which a hazardous situation caused by overheated brakes of the utility vehicle is to be prevented, the lift axle is lowered to maximize a braking force after an automatic stopping function of the utility vehicle has been activated. After activation of the automatic stopping function, the lift axle is only lowered when the utility vehicle reaches (or falls below) a predetermined speed in order to ensure that the speed difference between the vehicle wheels and the wheels of the lift axle is as small as possible when the vehicle is lowered to the ground, thereby preventing tire damage during braking. The method only lowers the lift axle when an automatic stop function is activated, that is, only in emergency situations and not in regular driving mode.

### SUMMARY

The influence of the lift axle on the dynamic driving behavior of the utility vehicle has not yet been taken into account.

It is an object of the disclosure to provide a method by which the vehicle-dynamics-related stability of a utility vehicle with a lift axle can be improved.

In a first aspect, the present disclosure achieves the object by a method for improving a vehicle-dynamics-related stability of a utility vehicle having a lift axle, the method including the steps of: determining a current ground speed of the utility vehicle; determining a stability-critical speed of the utility vehicle; comparing the current ground speed with the stability-critical speed; determining a lift status of the lift axle of the utility vehicle; and lowering the lift axle of the utility vehicle if the lift status represents a raised lift axle and the current ground speed is greater than or equal to the stability-critical speed. The method increases the vehicle-dynamics-related stability, in particular the yaw stability of the utility vehicle, by lowering the lift axle if the utility vehicle would be stability-critical when the lift axle is raised. The utility vehicle is preferably a vehicle combination including a towing vehicle and at least one trailer vehicle. In particular, lowering the lift axle can also increase the stability of a vehicle combination, especially since instabilities of a trailer vehicle resulting from excessive yaw excitation of the towing vehicle can be prevented.

To assess whether the utility vehicle is behaving in a stability-critical manner, a current ground speed of the utility vehicle is compared with a stability-critical speed of the utility vehicle. The current ground speed is the speed at which the utility vehicle is moving in the current situation, that is, the situation in which the method is being carried out. The stability-critical speed is a speed above which the utility vehicle is stability-critical. The utility vehicle is stability-critical if it becomes unstable as a result of normal steering stimuli. Usual steering excitations are steering excitations that can occur when driving a utility vehicle, in particular those that occur in emergency situations, for example during an evasive maneuver. According to various embodiments, the vehicle behaves in a stability-critical manner if the vehicle falls below a predetermined minimum level with which the vehicle damps predetermined excitations and/or if natural frequencies of the vehicle are in the range of normal excitation frequencies. The stability-critical damping ratio is preferably 0.6 or less, preferably 0.5 or less, preferably 0.4, wherein a damping ratio of 1 corresponds to the so-called aperiodic limiting case.

It should be understood that the utility vehicle is not necessarily unstable as soon as it is traveling at the stability-critical speed. Rather, the utility vehicle can become unstable in this case if a destabilizing excitation is applied to the vehicle when driving at a stability-critical speed. This can be the case, for example, if the utility vehicle has to perform an evasive maneuver or negotiate a curve with a small curve radius.

Furthermore, the method includes determining a lift status of the lift axle of the utility vehicle, which indicates whether the lift axle of the utility vehicle is lowered or raised. The lift status can represent at least a raised lift axle and a lowered lift axle, and can therefore be a digital status. However, it is also possible for the lift status to represent a measure of the lifting of the lift axle. For example, the lift status can represent a percentage value of an absolute stroke of the lift axle, wherein preferably a value of 100% represents a fully raised lift axle while a value of 0% represents a fully lowered lift axle.

To improve the vehicle-dynamics-related stability of the utility vehicle, the method also includes lowering the lift axle of the utility vehicle if the lift status represents a raised lift axle and the current ground speed is greater than or equal to the stability-critical speed. It is therefore not sensible or possible to lower the lift axle if it is already lowered. Lowering is therefore preferably only carried out when the lift axle has already been fully or partially raised. Furthermore, according to the disclosure, the lift axle is lowered when the utility vehicle is moving at a current ground speed that is greater than the determined stability-critical speed. According to various embodiments, the lowering of the lift axle is carried out independently of wear or economic considerations.

Lowering a lift axle, which is configured as a trailing axle, that is, an axle downstream of a drive axle in the direction of travel, reduces the effective lever arm for forces applied by a trailer. Furthermore, lowering the lift axle generally increases the potential lateral guidance forces of the vehicle, preventing the utility vehicle from swerving even at high steering frequencies. Both influences increase the driving stability and reduce the risk of instability of the utility vehicle. The method according to the disclosure takes into account the influence of a lift axle, in particular a lift axle configured as a trailing axle, on the driving stability of the utility vehicle.

The determination of a current ground speed of the utility vehicle and the determination of a stability-critical speed of the utility vehicle need not be carried out in the order. Preferably, the steps can also be performed in reverse order or (partially) simultaneously. The determination of the lift status can be performed before, after, completely simultaneously and/or partially simultaneously with the determination of the current ground speed, the determination of the stability-critical speed and/or the comparison of the speeds.

According to various embodiments, the method has the following features before determining a stability-critical speed of the utility vehicle: determining whether the utility vehicle is a vehicle combination of a towing vehicle and at least one trailer vehicle. The determination of whether the utility vehicle is a vehicle combination including a towing vehicle and at least one trailer vehicle is preferably performed using signals provided on a trailer network of the utility vehicle. Alternatively or in addition to detecting whether the utility vehicle is a vehicle combination using signals provided on a trailer network of the utility vehicle, the detection can also be carried out by determining using a total train mass of the utility vehicle and a towing vehicle mass of the towing vehicle.

According to various embodiments, the lift axle is a lift axle of the towing vehicle of a vehicle combination. However, the aforementioned stability advantages also apply to lift axles of a trailer, so that the lift axle can preferably also be a lift axle of a trailer vehicle. Furthermore, it should be understood that the utility vehicle can also have several lift axles, wherein preferably several, particularly preferably all lift axles of the utility vehicle are also lowered to increase the yaw stability

Determining the lift status can also be omitted and the lift axle can always be lowered when the current ground speed reaches or exceeds the stability-critical speed. For example, a lowering request can always be provided to a lift unit of the lift axle, which is intended for lowering the lift axle, as soon as the current ground speed reaches or exceeds the stability-critical speed. If the lift axle is already lowered in this case, the lowering request is ignored and/or leads to no result.

In a first embodiment of the method, the determination of the lift status of the lift axle of the utility vehicle includes: determining a lift axle wheel speed of at least one wheel of the lift axle; determining a reference wheel speed of at least one reference wheel of a reference axle of the utility vehicle; and comparing the lift axle wheel speed with the reference wheel speed, wherein the lift status represents a raised lift axle when the lift axle wheel speed falls below the reference wheel speed by a wheel speed tolerance value, and represents a lowered lift axle when the lift axle wheel speed is within a wheel speed tolerance range around the reference wheel speed. The wheel speed tolerance value, which can also be referred to as the wheel speed tolerance, is preferably provided to compensate for small speed differences resulting, for example, from different wheel diameters of the wheels of the lift axle and the reference axle or from wheel slip. The wheel speed tolerance range is a range of which the boundary values are determined by the reference wheel speed minus the wheel speed tolerance value and by the reference wheel speed plus the wheel speed tolerance value. When the lift axle is lowered, the wheels of the lift axle roll on the road surface. A rolling speed of the tire circumferential surface of the wheels of the lift axle is substantially identical to the rolling speed of the wheels of the other axles of the utility vehicle or a reference axle. The disclosure makes use of this finding. Thus, a lowered lift axle can be detected or determined if the wheels of the lift axle rotate at substantially the same wheel speed as the wheels of the reference axle, since the wheels of a utility vehicle generally have the same diameter. If the lift axle wheel speed is within the wheel speed tolerance range, then the lift axle is lowered. If, on the other hand, the lift axle is raised, its wheels generally do not rotate or only rotate very slowly. In this case, the lift axle wheel speed deviates from the reference wheel speed by more than the wheel speed tolerance value. The lift status can be determined particularly easily by observing the lift axle wheel speed and the reference wheel speed. According to various embodiments, the reference wheel is a driven wheel of the utility vehicle.

According to various embodiments, the determination of the lift status of the lift axle of the utility vehicle includes: determining lift status signals that are provided on a vehicle network, preferably a bus network, particularly a CAN bus, of the utility vehicle; and determining the lift status from the network data. Thus, a lift status already known in a vehicle system, for example a driving stability system such as an ABS or ESC system, can preferably be used in the method.

According to various embodiments, the method further includes: determining a lock status of a steerable auxiliary axle of the utility vehicle; and locking the steerable auxiliary axle of the utility vehicle if the lock status represents a currently steerable auxiliary axle and the current ground speed of the utility vehicle is greater than or equal to the stability critical speed. The steerable auxiliary axle is an auxiliary axle of the vehicle that can be steered. Furthermore, the alignment or steerability of the steerable auxiliary axle can also be locked. By locking, the steerable auxiliary axle is fixed in straight-ahead travel or its steerability is locked. When locked, the steerable auxiliary axle acts as a rigid axle. According to various embodiments, the steerable auxiliary axle is locked when driving straight ahead, that is, in an orientation that the steerable auxiliary axle assumes when the vehicle is driving straight ahead. Locking the steerable auxiliary axle generally shifts the driving behavior of utility vehicles towards understeering, which improves the stability of the vehicle. This means that the steerable auxiliary axle cannot shimmy or swing when locked.

According to various embodiments, the method also includes: raising the lift axle if the current ground speed of the utility vehicle reaches or falls below a stable speed, wherein the stable speed corresponds to the stability-critical speed minus a speed buffer. The stable speed is a speed at which the utility vehicle remains in a stable driving state even with the lift axle raised when a sudden excitation (in particular steering excitation) occurs. If the vehicle is moving at the stable speed, an evasive maneuver can also be performed with the lift axle raised without the utility vehicle becoming unstable. In this case, it makes sense to raise the lift axle in order to avoid the disadvantages of a lowered lift axle described above (increased wear, increased fuel consumption, increased toll charges, reduced maneuverability, et cetera). The speed buffer ensures that the lift axle is not raised immediately when the vehicle speed falls below the stability-critical speed. This ensures that the vehicle is moved in a stable speed range for a longer period of time before the lift axle is raised. Alternatively, it is also possible that the stable speed substantially corresponds to the stability-critical speed or that the speed buffer tends towards zero. Alternatively or additionally, the stable speed can also have a fixed value. The fixed value of the stable speed is preferably 15 km/h, 20 km/h or 25 km/h. For example, the lift axle can be raised even if the vehicle is moving at 15 km/h, although the stability-critical speed is less than 15 km/h.

According to various embodiments, the speed buffer is in a range of 1 km/h to 25 km/h, preferably 5 km/h to 25 km/h, preferably 5 km/h to 20 km/h, preferably 10 km/h to 20 km/h. The benchmark values of the claimed range are also preferred. The speed buffer can therefore preferably also be 1 km/h. Preferably, lifting only takes place when the current ground speed reaches or falls below the stable speed for a predetermined period of time. This prevents the lift axle from being raised in cases in which the vehicle only briefly falls below the stability-critical speed, for example as a result of a short braking maneuver. The predetermined time period can, for example, be 1 s (second) or more, preferably 2 s or more, preferably 3 s or more, preferably 4 s or more, preferably 5 s or more.

According to various embodiments, the lift axle of the utility vehicle is only lowered if the lift status represents a raised lift axle, the current ground speed is greater than or equal to the stability-critical speed, and the ground speed reaches a minimum speed. Preferably, the minimum speed has a value of 15 km/h or more, 20 km/h or more, 25 km/h or more, particularly preferably 30 km/h. In this way, the lowering of the lift axle can be prevented at low ground speeds, which generally offer only a low risk potential even with unfavorable vehicle, road and/or weather characteristics.

In a variant, determining a stability critical speed of the utility vehicle includes: predicting a lateral dynamic stability behavior of the utility vehicle based on a current vehicle configuration of the utility vehicle and defining the stability critical speed based on the predicted lateral dynamic stability behavior of the utility vehicle. According to various embodiments, the prediction of the lateral dynamic stability behavior of the utility vehicle is based at least in part on geometric characteristics of a trailer vehicle and/or load characteristics of the trailer vehicle if the utility vehicle is a vehicle combination. The geometric characteristics and load characteristics represent, at least in part, a current vehicle configuration of the utility vehicle, which concerns both vehicle-specific aspects and load-specific aspects. The geometric characteristics represent the geometry of the utility vehicle. In addition to or instead of geometric dimensions, the geometric characteristics may preferably also include quantity data (for example, a number of axles of the vehicle). Geometric characteristics are or include, in particular, geometric variables defining the driving dynamics of the vehicle, such as a wheelbase of the vehicle, axle spacings between axles of the vehicle, a track width of the vehicle, a distance between a rear axle of the vehicle and a coupling point of a trailer or a configuration form of a trailer vehicle (for example, drawbar trailer or center-axle trailer). The load characteristics represent loads acting on the vehicle that can result from the vehicle's own weight and from a load on the vehicle. Thus, a current vehicle configuration of an unloaded vehicle is different from a current vehicle configuration of the same vehicle when loaded. A load characteristic may preferably be or include a wheel load, an axle load, a total vehicle mass, a mass of a vehicle part and/or a center of gravity position of the vehicle or a vehicle part.

As part of the method, the determined geometric characteristics and load characteristics are taken into account when predicting the lateral dynamic behavior. By defining the stability-critical speed based on the predicted lateral dynamic stability behavior of the utility vehicle, the determined characteristics also have an influence on the definition of the stability-critical speed. The stability-critical speed is at least partially adapted to the current vehicle configuration. The time at which the lift axle is lowered can be determined particularly precisely. In this way, a risk of instability resulting from an unfavorable loading of the vehicle is detected and taken into account when defining the stability-critical speed.

By predicting the lateral dynamic stability behavior, a behavior of the vehicle can be predicted. The lateral dynamic stability behavior preferably includes a yaw behavior of the towing vehicle, an articulation behavior of the trailer vehicle or trailer vehicles, natural frequencies of the vehicle and/or damping values of the vehicle or the dynamic system formed by the vehicle. The prediction of the lateral dynamic stability behavior of the current vehicle configuration is preferably model-based. For this purpose, a basic vehicle model can preferably be individualized using the geometric characteristics and the load characteristics, and the lateral dynamic stability behavior of the vehicle can be determined using the individualized vehicle model.

According to various embodiments, the step of predicting a lateral dynamic stability behavior of the utility vehicle based on a current vehicle configuration of the utility vehicle includes: determining two or more geometric characteristics and two or more load characteristics of the current vehicle configuration; generating an individualized vehicle model of the current vehicle configuration using the geometric characteristics and the load characteristics; and predicting dynamic characteristics of the current vehicle configuration using the individualized vehicle model. According to various embodiments, the generation of an individualized vehicle model of the present vehicle configuration includes: approximating a mass distribution of the present vehicle configuration in at least one longitudinal direction of the vehicle using the geometric characteristics and the load characteristics; and generating an individualized vehicle model of the present vehicle configuration from a base vehicle model of the utility vehicle using the geometric characteristics and the approximated mass distribution.

In various embodiments, the determination of a stability-critical speed of the utility vehicle is or includes a selection of a pre-stored stability-critical speed from a memory in which at least one stability-critical speed is pre-stored. The pre-stored stability-critical speed of the utility vehicle is preferably stored in a memory of a control unit. Preferably, the pre-stored stability-critical speed has a fixed value. Furthermore, the determination of a stability-critical speed of the utility vehicle can also be a selection of a pre-stored stability-critical speed from a plurality of pre-stored stability-critical speeds. The selection is preferably made taking into account a current vehicle configuration. For example, a first pre-stored stability-critical speed can be selected if the utility vehicle does not include a trailer vehicle, and a second pre-stored stability-critical speed can be selected if the utility vehicle is a vehicle combination. The selection can also be based on a load condition. Thus, under otherwise identical conditions, a different stability-critical speed can be selected for a fully loaded utility vehicle than for an empty or partially loaded utility vehicle. Furthermore, the selection is preferably made taking into account current road conditions, with the method preferably including a determination of current vehicle conditions.

According to various embodiments, the pre-stored stability-critical speed is in a range of 20 km/h to 100 km/h, preferably 20 km/h to 90 km/h, preferably 20 km/h to 80 km/h, preferably 30 km/h to 80 km/h, preferably 30 km/h to 70 km/h, preferably 30 km/h to 60 km/h, preferably 30 km/h to 55 km/h, preferably 40 km/h to 55 km/h, particularly preferably 45 km/h to 55 km/h. Preferably, when selecting a pre-stored stability-critical speed from a memory, a stability-critical speed in a range of 45 km/h to 55 km/h is selected if the utility vehicle is located on a road within a built-up area, a stability-critical speed in a range of 56 km/h to 70 km/h is selected if the utility vehicle is driving on a country road, and/or a stability-critical speed in a range of greater than 70 km/h is selected if the vehicle is driving on a highway.

According to various embodiments, the determination of a stability-critical speed of the utility vehicle includes the following: approximating a current coefficient of friction for the utility vehicle; wherein the determination of the stability-critical speed of the utility vehicle is carried out using the approximated coefficient of friction. The determination of the current coefficient of friction can be subject to errors, so that the determined coefficient of friction only approximates a real prevailing coefficient of friction. The determined current coefficient of friction can therefore preferably also deviate from the actual coefficient of friction between the utility vehicle and a road on which the utility vehicle is traveling. In an embodiment of the method, a pre-stored stability-critical speed is selected as a function of the approximated coefficient of friction. For example, a speed of 50 km/h could be stability-critical for a high coefficient of friction, while a speed of 30 km/h is already stability-critical for low coefficients of friction. However, the coefficient of friction can alternatively or additionally be taken into account when predicting the lateral dynamic behavior.

According to various embodiments, the method further includes: determining dynamic route data, wherein the stability-critical speed of the utility vehicle is determined using the dynamic route data. For example, the stability-critical speed can have a greater value on a straight route than on a winding route or a route with a steep gradient. The lift axle can also only be lowered if the route data indicates a certain type of road. Knowledge of the route thus improves the targeted use of the method or the targeted lowering of the lift axle. For example, it is possible to prevent a lift axle from being permanently lowered when driving straight ahead on the highway, which would reduce the efficiency of utility vehicle operation. However, it may also be possible to lower the lift axle independently of the type of road. For example, the method can also be carried out during highway driving or the lift axle can be lowered if the dynamic route data indicates a hazardous situation, such as an oil lane ahead or a slippery road surface. If the stability-critical speed of the utility vehicle is determined using the dynamic route data, a dynamic stability-critical speed can preferably be determined first, for example based on the individualized vehicle model, and this can then be adapted to the stability-critical speed using the dynamic route data. For example, a dynamic stability-critical speed of 60 km/h can be reduced to a stability-critical speed of 50 km/h if there is a winding road ahead.

According to various embodiments, the lift axle of the utility vehicle is lowered even if the maximum permissible axle load of the utility vehicle is not reached when the lift axle is raised. The method is then carried out contrary to economic considerations.

In a second aspect, the disclosure solves the above-mentioned problem with a device for improving the vehicle-dynamics-related stability of a utility vehicle, which is configured to carry out a method according to the first aspect of the disclosure. According to various embodiments, the device for improving the vehicle-dynamics-related stability of a utility vehicle has a control unit and an interface, wherein the control unit is configured to provide a lowering request for a lift axle actuator at the interface if the lift status represents a raised lift axle and the current ground speed is greater than or equal to the stability-critical speed.

In a third aspect, the disclosure solves the aforementioned problem via a device for improving the vehicle-dynamics-related stability of a utility vehicle, wherein the utility vehicle has a lift axle, wherein the device has an interface and a control unit, wherein the control unit can be connected to at least one network of the utility vehicle for receiving signals and is configured to determine a current ground speed of the utility vehicle using the signals, to determine a stability-critical speed of the utility vehicle, to compare the current ground speed of the utility vehicle with the stability-critical speed of the utility vehicle using the signals, to determine a lift status of the lift axle using the signals, to provide a lowering request at the interface in order to trigger a lowering of the stability-critical speed of the utility vehicle, comparing the current ground speed of the utility vehicle with the stability-critical speed of the utility vehicle, using the signals to determine a lift status of the lift axle, providing a lowering request at the interface in order to cause the lift axle of the utility vehicle to be lowered if the lift status represents a raised lift axle and the current ground speed of the utility vehicle is greater than or equal to the stability-critical speed.

According to various embodiments, the control unit for receiving wheel speed signals representing at least one wheel speed of a reference wheel of the utility vehicle can be connected to a vehicle network of the vehicle, wherein the control unit is configured to determine the current ground speed of the utility vehicle based on the wheel speed signals.

In a fourth aspect, the aforementioned problem is solved with a utility vehicle including a lift axle and a device according to the second aspect of the disclosure and/or a device according to the third aspect of the disclosure. Preferably, the utility vehicle further includes a front axle and a rear axle. The lift axle is preferably a trailing axle of the utility vehicle.

According to a fifth aspect, the disclosure solves the aforementioned problem with a computer program product including program code means stored on a computer-readable data carrier for executing the method according to the first aspect of the disclosure when the program product is executed on a computing unit of a utility vehicle including a lift axle. The utility vehicle is preferably a utility vehicle according to the fourth aspect of the disclosure.

It should be understood that the devices for improving a vehicle-dynamics-related stability of a utility vehicle according to the second and/or third aspect of the disclosure, the utility vehicle according to the fourth aspect of the disclosure and the computer program product according to the fifth aspect of the disclosure may have the same and similar sub-aspects to the method according to the first aspect of the disclosure.

In a sixth aspect, the disclosure is solved by a method for improving a vehicle-dynamics-related stability of a utility vehicle, wherein the utility vehicle has a steerable auxiliary axle, the method including: determining a current ground speed of the utility vehicle; determining a stability-critical speed of the utility vehicle; comparing the current ground speed with the stability-critical speed; determining a lock status of the steerable auxiliary axle; and locking the steerable auxiliary axle of the utility vehicle in straight-ahead driving if the lock status represents a currently steerable auxiliary axle and the current ground speed of the utility vehicle is greater than or equal to the stability-critical speed. As already explained with reference to an embodiment of the first aspect of the disclosure, the vehicle-dynamics-related stability of a utility vehicle can be improved by locking a steerable auxiliary axle. For this purpose, the locking of the steerable auxiliary axle can also be carried out independently of a lowering of a lift axle, in particular even if the utility vehicle does not have a lift axle. The insight on which the disclosure is based, namely that stabilizing measures can advantageously be carried out as a function of a stability-critical speed, also applies to the sixth aspect of the disclosure or the locking of a steerable auxiliary axle independently of a lift axle. When locking the steerable auxiliary axle of the utility vehicle in straight-ahead travel, the steerable auxiliary axle is locked in an orientation that it has when the utility vehicle is traveling straight-ahead. The method according to the sixth aspect of the disclosure can be configured substantially analogously to embodiments of the first aspect of the disclosure with regard to embodiments.

### BRIEF DESCRIPTION OF DRAWINGS

The invention will now be described with reference to the drawings wherein:

FIG. 1 shows a utility vehicle with a lift axle;

FIG. 2 shows a first embodiment of the method;

FIG. 3 shows a diagram showing the course of a yaw reaction and an articulation curve for an evasive maneuver for a utility vehicle with a raised lift axle and for an otherwise identical utility vehicle with a lowered lift axle; and,

FIG. 4 shows a second embodiment of the method.

### DETAILED DESCRIPTION

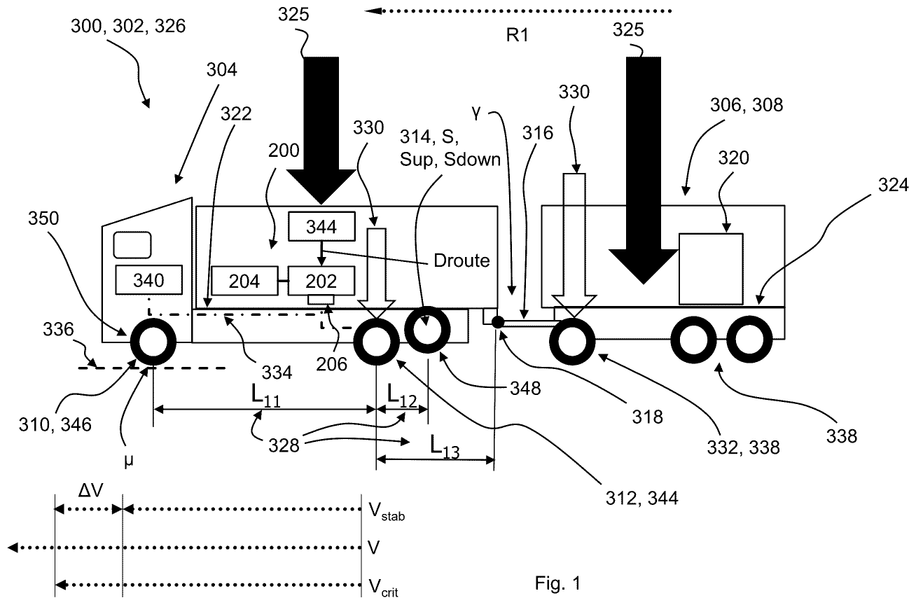

The method 1 is illustrated using the example of a utility vehicle 300, which is configured as a vehicle combination 302. The vehicle combination 302 shown in FIG. 1 includes a three-axle towing vehicle 304, which tows a two-axle trailer vehicle 306, which is configured as a drawbar trailer 308. The towing vehicle 304 includes a front axle 310, a first rear axle 312 and a lift axle 314. The lift axle 314 is arranged as a trailing axle behind the first rear axle 312 in a longitudinal direction R1 of the vehicle.

A loading situation that is frequently set for vehicle combinations 302 is characterized by the towing vehicle 304 being driven empty while the trailer vehicle 306 is loaded. This loading situation is chosen due to economic considerations, in particular if the trailer vehicle 306 has been leased while the towing vehicle 304 is owned by the operator. Thus, in the loading situation described, the trailer vehicle 306 in particular is subject to wear. Wear on the towing vehicle 304 is minimized due to the lack of load. A disadvantage, however, is that the stability of the utility vehicle 300 may be impaired due to the unfavorable load distribution.

The towing vehicle 304 has a first loading surface 322 for receiving a load 320. For the same purpose, the trailer vehicle 306 includes a second loading surface 324. The first loading surface 322 is empty, while a load 320 is arranged on the second loading surface 322. FIG. 1 is intended to illustrate via arrows 325 that a load on the trailer vehicle 306 is approximately twice as great as a load on the towing vehicle 304 resulting from the dead weight of the towing vehicle 304. This load distribution is unfavorable for the vehicle-dynamics-related stability of the utility vehicle 300. A drawbar 316 of the trailer vehicle 306 does not transfer any vertical loads to the towing vehicle 304, so that axle loads in the towing vehicle 304 do not deviate from its empty loads. For economic reasons, the lift axle 314 of the towing vehicle 304 is generally raised in this configuration, which further impairs the vehicle-dynamics-related stability of the utility vehicle 300.

The method 1 according to the disclosure is intended to improve the vehicle-dynamics-related stability of the utility vehicle 300 and in particular of the trailer vehicle 306, in particular by lowering the lift axle 314 depending on the situation.

However, it should be understood that the method 1 can also be used for utility vehicles 300 without a trailer vehicle 306 and for utility vehicles 300 with a center-axle trailer, in addition to the illustrated vehicle combination 302 with a towing vehicle 304 towing a drawbar trailer 308. The distance between a first rear axle 312 of the towing vehicle 304 and a coupling point 318 is significantly longer for a drawbar trailer 308 than for a low coupling system. A gain in stability, which is achieved by lowering the lift axle 314 as described later, is therefore generally greater for a utility vehicle 300 with a drawbar trailer 308 than for utility vehicles 300 with a center axle trailer. This gain in stability is particularly advantageous for utility vehicles 300 with a drawbar trailer 308, as a drawbar trailer 308 usually has several articulated joints (not shown in FIG. 1) and is therefore generally more sensitive to excitation than a center-axle trailer.

The utility vehicle 300 shown in FIG. 1 is characterized by a present vehicle configuration 326. This current vehicle configuration 326 includes both geometric characteristics 328 and load characteristics 330. The characteristics 328, 330 of the current vehicle configuration 326 of the utility vehicle 300 are illustrated in FIG. 1 for a better overview only via some geometric characteristics 328 and load characteristics 330. As geometric characteristics 328, an axle distance L11 between the front axle 310 and the first rear axle 312 of the towing vehicle 304 is shown as an example. Further geometric characteristics 328 shown in FIG. 1 are a coupling distance L13 between the first rear axle 312 and the coupling point 318 of the towing vehicle 304, and a lift axle distance L12 between the first rear axle 312 and the lift axle 314 of the towing vehicle 304. The geometric characteristics 328 of the present vehicle configuration 326 further include a lift status S of the lift axle 314, where the lift status S may represent a lowered lift axle 314 (lift status Sdown) and a raised lift axle 314 (lift status Sup). When the lift axle 314 is lowered, the dynamically effective wheelbase of the towing vehicle 304 changes from the axle distance L11 shown in FIG. 1 to a sum of the axle distance L11 and half the lift axle distance L12 (L11+L12/2).

The lateral dynamic stability behavior of the utility vehicle 300 is influenced by the wheelbase, wherein the lift status S of the lift axle 314 is a geometric characteristic 328 directly characterizing this influence. Further geometric characteristics 328 of the utility vehicle 300 shown are also a drawbar length of the drawbar 316 of the drawbar trailer 308 or a wheelbase of the trailer vehicle 306, which, however, are not explicitly identified in FIG. 1 for reasons of representation.

The load characteristics 330 characterize the loads acting on the utility vehicle 300 in the current vehicle configuration 326, which here result from the dead weight of the utility vehicle 300 and from the load 320. The load characteristics 330 are illustrated in FIG. 1 in simplified form as loads acting on the first rear axle 312 of the towing vehicle 304 and a front axle 332 of the trailer vehicle 306. As has already been explained, the trailer vehicle 306 is loaded while the towing vehicle 304 is empty, so that the load acting on the first rear axle 312 of the towing vehicle 304 is less than the load acting on the front axle 332 of the trailer vehicle 306. This is illustrated by the length of the arrows representing the load characteristics 330.

Here, the load characteristic 330 acting on the first rear axle 312 of the towing vehicle 304 is an axle load of the first rear axle 312. This axle load is determined by an electronically controllable air suspension of the utility vehicle 300. As a further load characteristic 330, the electronically controllable air suspension determines the axle load acting on the front axle 332 of the trailer vehicle 306. In the present embodiment, in addition to the determined axle load on the first rear axle 312 of the towing vehicle 304, a total mass of the towing vehicle 304 and the lift status S of the lift axle 314 are also known, so that an axle load on a front axle 310 of the towing vehicle 304 can be computationally determined by calculating the load distribution. Furthermore, based on the axle load of the front axle 332 of the trailer vehicle 306 and a known total mass of the trailer vehicle 306, an axle load on a rear axle of the trailer vehicle 306 can also be determined. In the present embodiment, the load characteristics 330 can therefore be recorded directly by measurement on the one hand and determined indirectly by calculation on the other.

The present vehicle configuration 326 may vary for the same utility vehicle 300 depending on the geometric characteristics 328 and the load characteristics 330. For example, a current vehicle configuration 326 of the utility vehicle 300 would be different from the current vehicle configuration 326 shown in FIG. 1 if the lift axle 314 of the utility vehicle 300 were lowered (that is, the lift status S would be different) or if the load 320 were disposed on the first loading surface 322 and not on the second loading surface 324. FIG. 1 is intended to illustrate that the current vehicle configuration 326 is situation-dependent and represents a current state of the utility vehicle 300.

A further factor that can be included in the current vehicle configuration 326 is a current coefficient of friction μ between the utility vehicle 300 and a road surface 336 indicated by a dashed line in FIG. 1. Even with an identical geometric configuration of the utility vehicle 300 and an identical load situation, the current vehicle configuration 326 of the utility vehicle 300 can vary due to different road surface conditions or due to a different coefficient of friction μ. In particular, the coefficient of friction μ makes it immediately clear that the current vehicle configuration 326 of the utility vehicle 300 can also change during operation of the utility vehicle 300. For example, the coefficient of friction μ can decrease during a journey of the utility vehicle 300 when rain sets in.

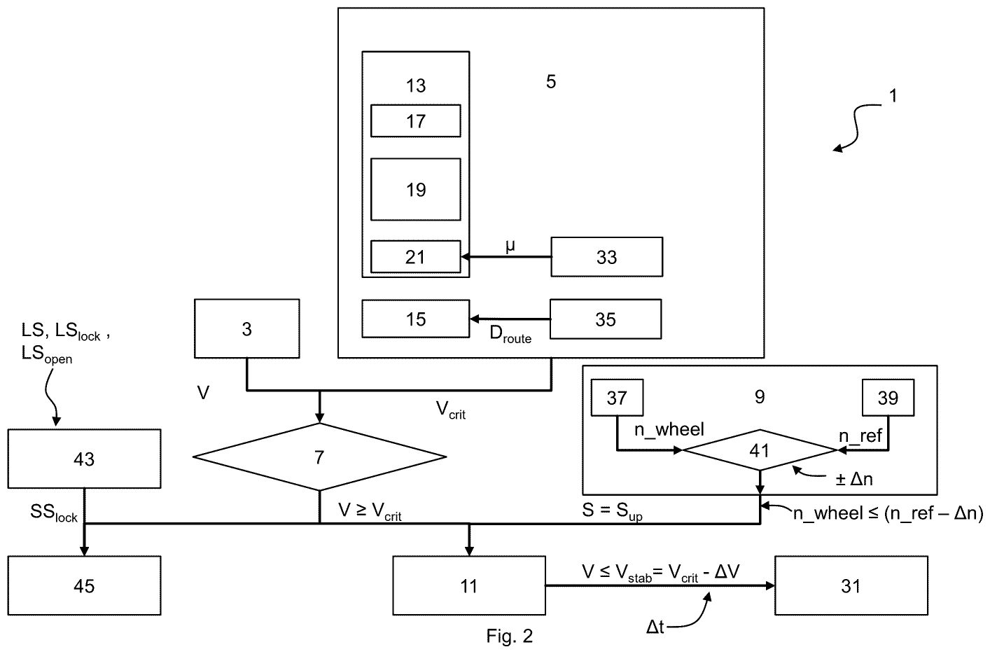

In the following, embodiments of the method 1 according to the disclosure for improving the vehicle-dynamics-related stability of the utility vehicle 300 are explained substantially with reference to FIG. 2 to FIG. 4. If necessary, individual aspects relating in particular to the utility vehicle 300 may also be explained with reference to FIG. 1.

FIG. 2 schematically shows a first embodiment of the method 1, in the context of which a current ground speed V of the utility vehicle 300 is first determined (determination 3 in FIG. 2). The determination 3 of the current ground speed V can, for example, be based on signals provided by a speedometer, a speed sensor and/or a control unit of the utility vehicle 300. Preferably, the determination 3 of the current ground speed V is carried out continuously or is repeated cyclically.

In the first embodiment, a determination 5 of a stability-critical speed Vcrit of the utility vehicle 300 is carried out simultaneously with the determination 3 of the current ground speed V. The simultaneous determination 3, 5 of the current ground speed V and the stability-critical speed Vcrit offers the advantage that the method 1 is streamlined and errors are reduced. However, it is also possible that the determination 3 of the current vehicle speed V is carried out before or after the determination 5 of the stability-critical speed Vcrit or that the steps of determining 3, 5 are carried out partially simultaneously. Thus, the determination 5 of the stability-critical speed Vcrit can preferably also be carried out during vehicle activation, for example by actuating the ignition or a drive switch of a utility vehicle 300.

After the determination 3, 5, a comparison 7 of the current ground speed V with the stability-critical speed Vcrit is carried out in the example shown. The result of the comparison 7 here is that the current ground speed V is greater than or equal to the stability-critical speed Vcrit (V≥Vcrit). In the event that the comparison 7 shows that the ground speed V is less than the stability-critical speed Vcrit (V<Vcrit), the method 1 is terminated and restarted if the ground speed V or an influencing factor on which the determination 5 is based changes. However, it may also be possible for method 1 to be restarted after a certain waiting time has elapsed. However, it may also be provided that one or more of the steps of the method 1 described below are also carried out if the comparison 7 shows that the ground speed V is less than the stability-critical speed Vcrit (V<Vcrit).

Simultaneously with the comparison 7 of the current ground speed V with the stability-critical speed Vcrit, the lift status S of the lift axle 314 is determined (determination 9 in FIG. 2). Here, this determination 9 shows that the lift status S is a lift status Sup, which represents a raised lift axle 314. However, it may also be provided that the determination 9 of the lift status S takes place before, after or simultaneously with the comparison 7 of the speeds V, Vcrit. According to various embodiments, the lift status S is determined when the vehicle is activated.

In the embodiment shown in FIG. 2, the current vehicle speed V is greater than the stability-critical speed Vcrit and the lift axle 314 of the utility vehicle 300 is raised (S=Sup). For this reason, the lift axle 314 of the utility vehicle 300 is lowered in a further step.

As already explained at the outset, the relevant wheelbase of the utility vehicle in terms of driving dynamics is thus extended from the axle distance L11 to the sum of the axle distance L11 and half of the lift axle distance L12. This increases the driving stability of the towing vehicle 304. By increasing the effective wheelbase of the utility vehicle in terms of driving dynamics from L11 to L11+L12/2, the ability of the towing vehicle 304 to follow changes in direction is reduced, as a result of which the towing vehicle 304 achieves lower yaw rates and is stabilized.

Furthermore, the distance between the coupling point 318 and a dynamically effective contact point of the towing vehicle 304 at the rear is reduced from the coupling distance L13 to the difference between the coupling distance L13 and half the lift axle distance L12 (L13−L12/2). This reduces a lever arm for forces transmitted from the trailer vehicle 306 or the drawbar 316 to the towing vehicle 304. As a result, a kinematic drag curve of the coupling point 318 describes a larger curve radius when cornering if the lift axle 314, which is configured as a trailing axle, is lowered in the utility vehicle 300. This results in a reduced deflection of the drawbar trailer 308, which reduces the risk of the trailer vehicle 306 breaking away in a hazardous situation. An evasive maneuver (lane or double lane change), in which a yaw reaction of the utility vehicle 300 is built up with high steering angle amplitudes and steering angle speeds, is an example of such a hazardous situation.

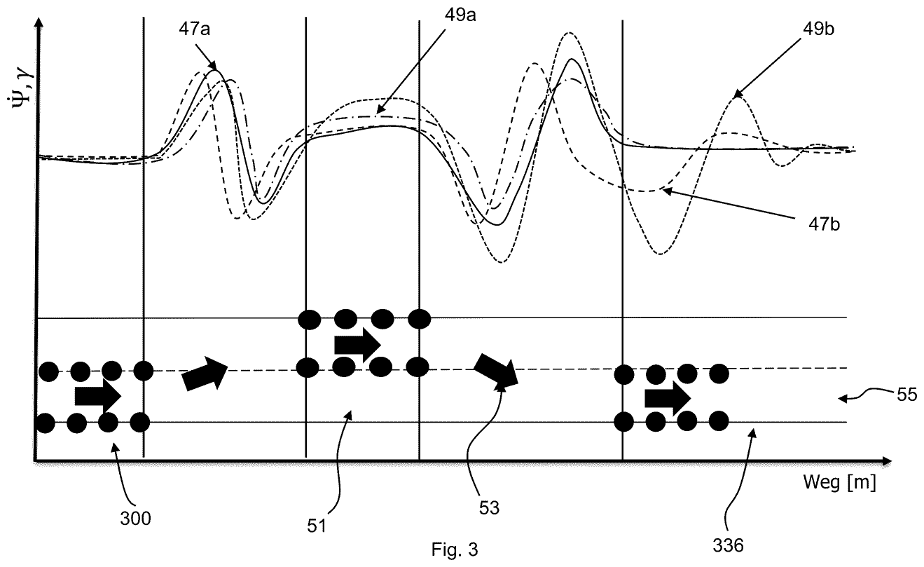

FIG. 3 shows a yaw reaction and an articulation angle curve along the path for a vehicle combination 302 with a raised lift axle 314 (the vehicle combination 302 is only shown in simplified form in FIG. 3), which performs an evasive maneuver that is a double lane change maneuver. Similarly, FIG. 3 illustrates the course of the yaw rate Ψ and the articulation angle γ along the path for an otherwise identical vehicle combination 302 with raised lift axle 314, which performs the identical evasive maneuver. In short, FIG. 3 thus shows a comparison of the yaw response and the articulation angle curve for a vehicle combination 302 with a lowered lift axle 314 and a vehicle combination 302 with a raised lift axle 314.

The articulation angle curve describes the course over time of the articulation angle γ formed between the towing vehicle 304 and the trailer vehicle 306. For a trailer vehicle 306 driving exactly straight behind the towing vehicle 304, the articulation angle γ has a value of 0°. During cornering or an evasive maneuver, the articulation angle γ decreases or increases accordingly. The yaw reaction relates to the course of the yaw rate Ψ of the utility vehicle 300 along a path traveled by the utility vehicle 300. In FIG. 3, line 47a (solid line) indicates the course of the yaw rate Ψ with the lift axle 314 lowered and line 47b (rough dashed line) indicates the course of the yaw rate Ψ with the lift axle 314 raised. Similarly, line 49a (dash-dot line) indicates the course of the articulation angle with the lift axle 314 lowered and line 49b (fine dashed line) indicates the course of the articulation angle with the lift axle 314 raised.

FIG. 3 illustrates that the yaw rate Ψ with the lift axle 314 lowered reaches both a flatter gradient and a lower maximum in the course 47a for an otherwise identical evasive maneuver 51 than the course 47b of the yaw rate Ψ for the vehicle combination 302 with the lift axle 314 raised. This is due to an earlier onset of understeering driving behavior of the utility vehicle 300. In addition, the articulation angle γ between the trailer vehicle 306 or drawbar 316 and the towing vehicle 304 decreases when the lift axle 314 is lowered. Yaw damping of the utility vehicle 300 is increased, so that excitation of the vehicle combination 302 by the trailer vehicle 306 is better damped when the lift axle 314 is lowered (line 49a) than when the lift axle 314 is raised (line 49b). The increased driving stability of the utility vehicle 300 is shown in particular by the small articulation angles γ between the towing vehicle 304 and the trailer vehicle 306 when steering back 53 into an exit lane 55 and the subsequent straight route. Particularly in the case of utility vehicles 300 configured as a vehicle combination 302, the driving stability is significantly increased by lowering 11 the lift axle 314. However, driving stability can also be improved in the case of utility vehicles 300 without a trailer vehicle 306, in particular if the wheelbase of such a utility vehicle 300 is short and/or the utility vehicle 300 is loaded to the rear.

In the embodiment according to FIG. 2, the stability-critical speed Vcrit is determined 5 by predicting 13 a lateral dynamic stability behavior of the utility vehicle 300 and defining 15 the stability-critical speed Vcrit based on the predicted lateral dynamic stability behavior of the utility vehicle 300.

In a first step of predicting 13, two or more geometric characteristics 328 and two or more load characteristics 330 are determined 17. The determined geometric characteristics 328 include the axle distance L11, the lift axle distance L12, the coupling distance L13 and the lift status S. The coupling distance L13 can, for example, be determined via an axle formula of the utility vehicle 300 using a type of trailer vehicle 306 (center axle trailer or drawbar trailer 308). The type of trailer vehicle 306 can, for example, be determined based on signals from a trailer network (not shown in the figures), which can in particular be an ISO 11992 CAN. Simultaneously with the determination of the geometric characteristics 328, two or more load characteristics 300, which are only partially illustrated in FIG. 2 for reasons of clarity, are determined. In the present embodiment, the load characteristics 330 include axle loads acting on the front axle 310 and the first rear axle 312 of the towing vehicle 304. Furthermore, the load characteristics 330 include axle loads acting on axles 338 of the trailer vehicle 306, of which only the axle load acting on the front axle 332 of the trailer vehicle 306 is illustrated as load characteristic 330 in FIG. 1. According to various embodiments, however, the load characteristics 330 also include only a towing vehicle total mass of the towing vehicle 304 and a trailer vehicle total mass of the trailer vehicle 306, and/or a mass distribution of the utility vehicle 300, wherein the mass distribution is a ratio formed from the towing vehicle total mass and the trailer vehicle total mass.

The determination 17 of the geometric characteristics 328 and the load characteristics 330 is performed for the first time during a vehicle activation of the utility vehicle 300. A vehicle type of the utility vehicle 300 and geometric characteristics 328 (number of axles 310, 312, 314, 338, axle spacing L11) are already known when an ignition of the utility vehicle 300 is activated. Further characteristics of the axles 310, 312, 314, 338 are also available. These are stored here as geometric characteristics 328 in an ESC control unit 340 of the utility vehicle 300, which in the event of instability intervenes in a regulating manner in driving operation, for example by initiating braking of an outer wheel of an oversteering utility vehicle 300. In the present case, the trailer vehicle 306 has an electronic braking system (EBS). The trailer vehicle 306 is connected to the towing vehicle 304 via a trailer interface (not shown in FIG. 1), which can be configured as an ISO11992 interface. The trailer vehicle 306 provides signals to the towing vehicle 304 on the trailer interface, which are used to determine the geometric characteristics 328 of the trailer vehicle 306. The geometric characteristics 328 of the trailer vehicle 306 include a model type of the trailer vehicle 306, a number of axles 338 of the trailer vehicle 306 and their distances from the coupling point 318. These geometric characteristics 328 of the trailer vehicle 306 are provided here directly at the ISO11992 interface, so that determining the characteristics 328, 330 of the trailer vehicle 306 is a receiving of the corresponding signals. In addition, the EBS trailer vehicle 306 has sensors (not shown in FIG. 1) that are assigned to the axles 338. These sensors determine axle loads present at the sensed axles 338 and provide corresponding signals at the trailer interface. These signals are in turn used to determine the axle loads of the trailer vehicle 306 as load characteristics 330. Furthermore, the determination 17 here includes a calculation of an axle load on the front axle 310 of the towing vehicle 304.

Following the determination 17 of the geometric characteristics 328 and load characteristics 330, in a next step of the method 1 an individualized vehicle model of the current vehicle configuration 3 is generated from a basic vehicle model of the utility vehicle 300 (generate 19 in FIG. 2). The individualized vehicle model can be a single-track model of the utility vehicle 300 which, as a simplified model of the utility vehicle 300, depicts the towing vehicle 304 and the trailer vehicle 306 from FIG. 1 in their minimum coordinates, wherein the vehicle width approaches zero and lifting, rolling or pitching movements of the utility vehicle 300 can be neglected.

The individualized vehicle model is generated 19 using the geometric characteristics 328 and the load characteristics 330. For this purpose, a mass distribution of the current vehicle configuration 326 is approximated in the vehicle longitudinal direction R1. Subsequently, when generating 19 the individualized vehicle model, a parameterized basic vehicle model of the utility vehicle 300 is preferably individualized by applying the geometric characteristics 328 and the load characteristics 330, wherein the determined characteristics 328, 330 and the mass distribution are used as parameter values in the basic vehicle model.

Using the individualized vehicle model, dynamic properties, in particular lateral dynamic properties, of the current vehicle configuration 326 are then predicted (prediction 21 in FIG. 2). In the present embodiment, the dynamic properties determined during prediction 21 are natural cycle frequencies and damping measures for eigenvalues of the individualized vehicle model. In FIG. 1, the utility vehicle 300 is driving in a stationary straight line and is stable. However, due to the rear-heavy load, the utility vehicle 300 is susceptible to instability in the event of a sudden evasive maneuver 51 (see FIG. 3), which is characterized by a high steering angle frequency. Depending on the current ground speed V, the trailer vehicle 306 may not be sufficiently damped against an excitation of the utility vehicle 300 caused by the evasive maneuver and may break away. A control unit 202 of the utility vehicle 300 is configured to determine, based on the determined dynamic properties, from which current ground speed V the utility vehicle 300 becomes unstable for a typical steering excitation of an evasive maneuver 51. The control unit 202 defines this speed as the stability-critical speed Vcrit. The control unit 202 is also configured here for predicting 21 the dynamic properties, for determining the characteristics 328, 330 and for generating 19 the individualized vehicle model.

In the embodiments of the method 1, an approximation 33 of a current coefficient of friction μ for the utility vehicle 300 is also provided. In the embodiment according to FIG. 2, the stability-critical speed Vcrit of the utility vehicle 300 is determined 5 using the approximated coefficient of friction μ. The coefficient of friction μ is taken into account when predicting 21 the dynamic properties of the utility vehicle 300 by using the coefficient of friction μ as a parameter value of the model when generating 19 the individualized vehicle model. By determining 33 the current coefficient of friction μ for the utility vehicle 300, the quality of the prediction 21 of the dynamic characteristics of the current vehicle configuration 326 is further improved. In reality, fluctuations in the current coefficient of friction μ often occur. For example, the coefficient of friction μ between the utility vehicle 300 and the road surface 336 may be reduced in wet or icy conditions compared to dry conditions. This results in a considerable influence on the dynamic properties of the utility vehicle 300. If the current coefficient of friction μ is taken into account when predicting 21 the dynamic properties, this may have an effect on the determined stability-critical speed Vcrit and the safety when operating the utility vehicle 300 is increased. However, the dynamic properties of the utility vehicle 300 can also be predicted without taking the current coefficient of friction μ into account, wherein the predicted dynamic properties may then be subject to errors. For safety reasons, a low coefficient of friction μ can then be assumed when predicting 21, so that the stability-critical speed Vcrit may be lower than necessary.

Furthermore, in the method 1 according to FIG. 2, when defining 15 the stability-critical speed Vcrit, dynamic route data Droute that was determined in a previous step is also taken into account (determining 35 in FIG. 2). Thus, a stability-critical speed Vcrit derived from the predicted dynamic characteristics of the current vehicle configuration 326 can be reduced here using the route course data Droute if the route course data Droute represents a winding route. The determination 35 of the route course data Droute is performed by a navigation system 344 of the towing vehicle 304, which provides the route course data Droute to the control unit 202.

After lowering 11 the lift axle 314, the utility vehicle 300 continues to perform a driving task, for example a journey from a point A to a point B. In the course of the driving task, the ground speed V of the utility vehicle 300 can vary, so that it can be sometimes greater and sometimes less than the critical speed Vcrit. If the utility vehicle 300 is moving at a current ground speed V that is less than the stability-critical speed Vcrit, then the lift axle 314 does not necessarily have to be lowered to stabilize the utility vehicle 300. In the first embodiment (FIG. 2), the lift axle 314 is therefore raised if the current ground speed V of the utility vehicle 300 reaches or falls below a stable speed Vstab (V≤Vstab).

The ground speed V, the stable speed Vstab and the stability-critical speed Vcrit are illustrated in FIG. 1. The stable speed Vstab corresponds to the stability-critical speed Vcrit minus a speed buffer ΔV (Vstab=Vcrit−ΔV). The speed buffer ΔV ensures that the lift axle 314 is not raised immediately when the speed falls below the stability-critical speed Vcrit. This prevents the lift axle 314 from being raised (and lowered) by the stability-critical speed Vcrit even if the current ground speed V fluctuates slightly. Furthermore, the speed buffer ΔV ensures that the lift axle 314 is only raised when the utility vehicle 300 is moved safely within a stable speed range. The lower the current ground speed V, the lower the risk of instabilities occurring, so that the provision of the speed buffer ΔV further increases the increase in safety provided by the method 1. Furthermore, errors, in particular measurement errors, can be compensated for when determining 3 the current vehicle speed V. Furthermore, it can be provided that the lift axle 314 is only raised when the current ground speed V falls below the stable speed Vstab for a predetermined period of time Δt. This prevents the lift axle 314 from being raised when the utility vehicle 300 brakes briefly, for example to increase the distance to another vehicle entering the lane in front of the utility vehicle 300.

To achieve a further improvement in the lateral vehicle-dynamics-related stability of the utility vehicle 300, the method 1 includes a locking 45 of a steerable auxiliary axle 344. In the embodiment shown in FIG. 1, the first rear axle 312 of the towing vehicle 304 is the steerable auxiliary axle 344. This steerable auxiliary axle 344 can be locked, wherein the locking 45 increases the vehicle-dynamics-related stability of the towing vehicle 304 and thus of the entire vehicle combination 302. In the method 1, the locking 45 of the steerable auxiliary axle 344 only takes place if the current ground speed V is greater than or equal to the stability-critical speed Vcrit and if a lock status LS indicates that the steerable auxiliary axle 344 is unlocked or open. If, on the other hand, the steerable auxiliary axle 344 is already locked, which is represented by a lock status LSlock, locking 45 can be omitted.

The lock status LS is determined in a previous step (determination 43 in FIG. 2). Determining 43 the lock status LS is performed by determining lock signals provided on a vehicle network 334 of the utility vehicle 300, and determining the lock status LS using the lock signals. In the embodiment shown, the ESC control unit 340 provides the lock status LS on a vehicle network 334, which here is an ISO 11992 CAN bus. The control unit 202 receives the lock signals and uses them to determine the lock status LS.

In the first embodiment of the method 1 (see FIG. 2), the lift status S of the lift axle 314 is determined 9 based on wheel speeds n_wheel, n_ref of the lift axle 314 and a reference axle 346 of the utility vehicle 300. The reference axle 346 is preferably a driven axle of the utility vehicle 300. In the present case, the front axle 310 of the utility vehicle 300 forms the reference axle 346. The determination 9 of the lift status includes determining 37 a lift axle wheel speed n_wheel of wheels 348 of the lift axle 314 and determining 39 a reference wheel speed n_ref of reference wheels 222, which in this case are front wheels of the utility vehicle 300. After determining 37 the lift axle wheel speed n_wheel and determining 39 the reference wheel speed n_ref, these two wheel speeds n_wheel, n_ref are compared 41. In FIG. 2, the comparison 41 shows that the lift axle wheel speed n_wheel is less than or equal to the reference wheel speed n_ref minus a wheel speed tolerance value Δn (n_wheel≤n_ref−Δn).

While the utility vehicle 300 is moving at the ground speed V, the reference wheels 350 roll on the road surface 336, wherein a tire rolling speed of the reference wheels 350 corresponds approximately to the ground speed V. The reference wheel speed n_wheel corresponds to the tire rolling speed of the reference wheels 350 and is significantly greater than zero at higher ground speeds V. When the lift axle 314 is raised, its wheels 348 are not resting on the road surface 336, so that the lift axle wheel speed n_wheel has a value of zero or slightly greater than zero in this case. A large difference between the reference wheel speed n_ref and the lift axle wheel speed n_wheel therefore corresponds to a raised lift axle 314 or a lift status Sup, which represents a raised lift axle 314.

If, on the other hand, the lift axle 314 is lowered, then its wheels 348 also stand on the road surface 336 and roll along it. The tire rolling speed of the reference wheels 350 and the wheels 348 of the lift axle 314 is substantially identical if all wheels 348, 350 have the same circumference. Therefore, a lowered lift axle 314 or a lift status Sdown representing a lowered lift axle 314 can be determined if a lift axle wheel speed n_wheel of the wheels 348 of the lift axle 314 is within a wheel speed tolerance range±Δn around the reference wheel speed n_ref of the reference wheels 350. In the embodiment of the method 1 shown, the wheel speed tolerance value Δn is intended to compensate for inaccuracies or errors when determining 37, 39 the wheel speeds n_wheel, n_ref. Such inaccuracies can result, for example, from slight deviations in the diameter of nominally equally large wheels 348, 350. According to various embodiments, the wheel speed tolerance range ±Δn has a width of 100 rpm or less, preferably 50 rpm or less, particularly preferably 15 rpm or less. According to various embodiments, the determination 9 can also only take place if the lift axle wheel speed n_wheel is constant for a predetermined period of time, for example a period of two seconds

The lift axle 314 of the utility vehicle 300 shown in FIG. 1 is raised, so that the lift axle wheel speed n_wheel is significantly lower than the reference speed n_ref of the reference wheels 350 on the front axle 310 of the utility vehicle 300 (n_ref−n_wheel>Δn) and the determination 9 of the lift status S of the lift axle 314 results in a lift status Sup, which represents a raised lift axle 314.

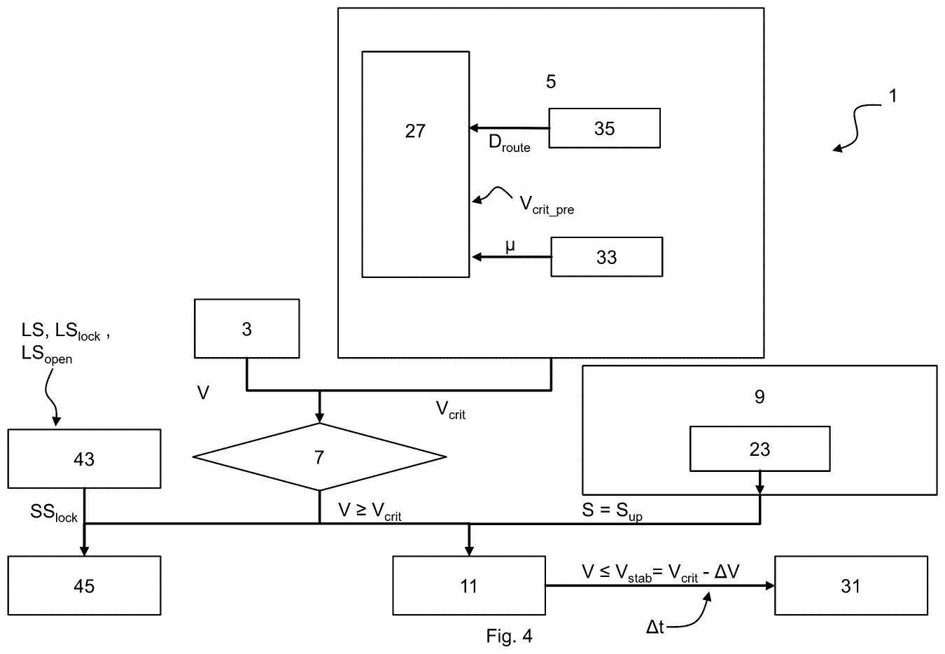

FIG. 4 illustrates a second embodiment of the method 1, wherein the same steps are marked with the same reference signs. The method 1 according to the second embodiment differs from the method 1 according to FIG. 2 substantially in the determination 5 of the stability-critical speed 5 and in the determination 9 of the lift status S.

In the method 1 according to the second embodiment, the determination 5 of the stability-critical speed Vcrit includes a selection 27 of a pre-stored stability-critical speed vcrit_pre from a memory 204. The selection 27 is made here by the control unit 202, wherein the memory 204 is a memory 204 of the control unit 202. Analogous to the first embodiment, an approximation 33 of the coefficient of friction μ and a determination 35 of dynamic route data Droute are also carried out in the method 1 according to the second embodiment. The selection 27 of the pre-stored stability-critical speed Vcrit_pre is a parameter-based selection of a pre-stored stability-critical speed Vcrit_pre from a plurality of stability-critical speeds Vcrit_pre pre-stored in the memory 204. It may also be provided that the selection 27 is a map-based selection in which relevant characteristic values (type of trailer vehicle 306, mass distribution of the utility vehicle 300, towing vehicle mass, trailer vehicle mass, axle loads, geometric characteristics 328, et cetera) are represented. As part of the selection 27, geometric characteristics 328 and load characteristics 330 of the current vehicle configuration 330 are taken into account in addition to the route data Droute and the coefficient of friction μ. Thus, at of the selection 27, a pre-stored stability-critical speed Vcrit_pre corresponding to the geometric characteristics 328 and the load characteristics 330 is selected and then adapted to the route data Droute and the current coefficient of friction μ.

With reference to the utility vehicle 300 shown in FIG. 1, a pre-stored stability-critical speed Vcrit_pre is thus selected, which is stored for a vehicle combination 202 that has an unloaded towing vehicle 304 and a loaded trailer vehicle 306. If the determined coefficient of friction μ has a low value, that is, adhesion between the utility vehicle 300 and the road surface 336 is low, then this pre-stored stability-critical speed Vcrit_pre can be reduced in accordance with the determined current coefficient of friction μ. For example, a pre-stored stability-critical speed Vcrit_pre of 65 km/h can be selected for the vehicle 300 shown in FIG. 1 and reduced to a stability-critical speed Vcrit of 50 km/h when the coefficient of friction μ is low (that is, when the road surface is smooth). Similarly, the pre-stored stability-critical speed Vcrit_pre can be reduced if the Droute route data represents a winding route.

Alternatively, it may be provided that the track course data Droute and/or the current coefficient of friction μ are part of the parameter combination and the stability-critical speeds vcrit_pre pre-stored in the memory 204 are stored to match these parameter combinations. According to various embodiments, the pre-stored stability-critical speed vcrit_pre that comes closest to the parameter combination is selected. For example, the selection can include 27 an interpolation and/or averaging of several pre-stored stability-critical velocities vcrit_pre.

In the second embodiment (see FIG. 4), the lift status S is not determined 9 directly by determining wheel speeds n_ref, n_wheel (see the first embodiment according to FIG. 2), but by determining 23 lift status signals that are provided on the vehicle network 334, which is configured as an ISO 11992 CAN bus. The lift status S can then be determined based on the determined lift status signals. Here, the ESC control unit 340 provides the lift status signals on the vehicle network 334. The ESC control unit 340 can provide the lift status signals based, for example, on axle load sensor data representing an axle load on the lift axle 314, or based on data from a displacement sensor and/or limit switch associated with the lift axle 314.

The control unit 202 and the memory 204 are here part of a device 200 for improving the vehicle-dynamics-related stability of a utility vehicle 300, which is configured to carry out the method 1. The device 200 further includes an interface 206, which is formed here on the control unit 202. Via the interface 206, the control unit 202 can provide a lowering request. In the utility vehicle 300 according to FIG. 1, the interface 206 is connected to the vehicle network 334, so that the control unit 202 provides the lowering request for lowering 11 the lift axle 314 on the vehicle network 334. The vehicle network 334 is connected to the lift axle 314 or to a lift unit (not shown) of the lift axle 314, which receives the lowering request. In response to receiving the lowering request provided by the device 200, the lift unit lowers the lift axle 314. Similarly, the lift unit raises the lift axle 314 when it receives a lift request provided on the vehicle network 334.

It is understood that the foregoing description is that of the preferred embodiments of the invention and that various changes and modifications may be made thereto without departing from the spirit and scope of the invention as defined in the appended claims.

### REFERENCE SIGNS (PART OF THE DESCRIPTION)

1 method
3 determination of the current ground speed
5 determination of a stability-critical speed
7 comparison of the current ground speed with the stability-critical speed
9 determination of the lift status of the lift axle
11 lowering of the lift axle
13 prediction of the lateral dynamic stability behavior of the utility vehicle
15 defining of the stability-critical speed
17 determination of geometric characteristics and load characteristics
19 generation of an individualized vehicle model
21 prediction of dynamic properties
23 determination of lift status signals
27 selection of a pre-stored stability-critical speed
31 lifting of the lift axle
33 approximation of a current coefficient of friction
35 determination of dynamic route data
37 determination of a lift axle wheel speed;
39 determination of a reference wheel speed
41 comparison of the lift axle wheel speed with the reference speed
43 determination of a lock status
45 locking of the steerable auxiliary axle
47a yaw rate curve with lowered lift axle
47b yaw rate curve with raised lift axle
49a articulation angle curve with lowered lift axle
49b articulation angle curve with raised lift axle
51 evasive maneuver
53 reverse steering
55 exit lane
200 device for improving vehicle-dynamics-related stability
202 control unit
204 memory
206 interface
300 utility vehicle
302 vehicle combination
304 towing vehicle
306 trailer vehicle
308 drawbar trailer
310 front axle
312 first rear axle
314 lift axle
316 drawbar
318 coupling point
320 load
322 first loading surface
324 second loading surface
325 arrows
326 current vehicle configuration
328 geometric characteristics
330 load characteristics
332 front axle of the trailer vehicle
334 vehicle network
336 road surface
338 axles of the trailer vehicle
340 ESC control unit
344 steerable auxiliary axle
346 reference axle
348 wheels of the lift axle
350 reference wheels
Droute route data
L11 axle distance
L12 lift axle distance
L13 coupling distance
n_ref reference wheel speed
n_wheel lift axle wheel speed
R1 vehicle longitudinal direction
S lift status
Sdown lift status that represents a lowered lift axle
LS lock status
LSlock lock status that represents a locked steerable auxiliary axle
LSopen lock status that represents an unlocked steerable auxiliary axle
Sup lift status that represents a raised lift axle
V current ground speed
Vcrit stability-critical speed
Vcrit_pre pre-stored stability-critical speed
Vstab stable speed
Δn wheel speed tolerance value
±Δn wheel speed tolerance range
ΔV speed buffer
γ articulation angle
μ current coefficient of friction
Ψ yaw rate

1. A method for improving a vehicle-dynamics-related stability of a utility vehicle, wherein the utility vehicle has a lift axle, the method comprising:
determining a current ground speed of the utility vehicle;
determining a stability-critical speed of the utility vehicle;
comparing the current ground speed with the stability-critical speed;
determining a lift status of the lift axle of the utility vehicle; and,
lowering the lift axle of the utility vehicle if the lift status represents a raised lift axle and the current ground speed is greater than or equal to the stability-critical speed.

2. The method of claim 1, wherein said determining the lift status of the lift axle of the utility vehicle includes:
determining a lift axle wheel speed of at least one wheel of the lift axle;
determining a reference wheel speed of at least one reference wheel of a reference axle of the utility vehicle; and,
comparing the lift axle wheel speed with the reference wheel speed;
wherein the lift status represents the raised lift axle when the lift axle wheel speed falls below the reference wheel speed by a wheel speed tolerance value, and represents a lowered lift axle when the lift axle wheel speed is within a wheel speed tolerance range around the reference wheel speed.

3. The method of claim 1 further comprising:
determining a lock status of a steerable auxiliary axle of the utility vehicle; and,
locking the steerable auxiliary axle of the utility vehicle, if the lock status represents a movable currently steerable auxiliary axle and the current ground speed of the utility vehicle is greater than or equal to the stability-critical speed.

4. The method of claim 1 further comprising raising the lift axle if the current ground speed of the utility vehicle reaches or falls below a stable speed, wherein the stable speed corresponds to the stability-critical speed minus a speed buffer.

5. The method of claim 4, wherein the speed buffer is in a range from 1 km/h to 25 km/h.

6. The method of claim 4, wherein the speed buffer is in a range from 10 km/h to 20 km/h.

7. The method of claim 1, wherein said determining the stability-critical speed of the utility vehicle includes:
predicting a lateral dynamic stability behavior of the utility vehicle based on a current vehicle configuration of the utility vehicle; and,
defining the stability-critical speed based on the predicted lateral dynamic stability behavior of the utility vehicle.

8. The method of claim 7, wherein said predicting the lateral dynamic stability behavior of the utility vehicle based on the current vehicle configuration of the utility vehicle includes:
determining two or more geometric characteristics and two or more load characteristics of the current vehicle configuration;
generating an individualized vehicle model of the current vehicle configuration using the geometric characteristics and the load characteristics; and,
predicting dynamic characteristics of the current vehicle configuration using the individualized vehicle model.

9. The method of claim 1, wherein said determining the stability-critical speed of the utility vehicle is a selection of a pre-stored stability-critical speed from a memory in which at least one stability-critical speed is pre-stored.

10. The method of claim 9, wherein the pre-stored stability-critical speed is in a range from 20 km/h to 100 km/h.

11. The method of claim 9, wherein the pre-stored stability-critical speed is in a range from 30 km/h to 60 km/h.

12. The method of claim 9, wherein the pre-stored stability-critical speed is in a range from 45 km/h to 55 km/h.

13. The method of claim 1, wherein said determining the stability-critical speed of the utility vehicle includes approximating a current coefficient of friction for the utility vehicle; and, said determining the stability-critical speed of the utility vehicle is carried out using the approximated current coefficient of friction.

14. The method of claim 1 further comprising determining dynamic route data; and, wherein said determining the stability-critical speed of the utility vehicle is carried out using the dynamic route data.

15. The method of claim 1, wherein said lowering of the lift axle of the utility vehicle also takes place if a maximum permissible axle load of the utility vehicle is undershot when the lift axle is raised.

16. A device for improving a vehicle-dynamics-related stability of a utility vehicle, which device is configured to perform the method of claim 1.

17. A utility vehicle comprising a lift axle and the device of claim 16.

18. A computer program product comprising program code stored on a non-transitory computer-readable data carrier, said program code being configured, when executed by a computing unit of a utility vehicle having a lift axle, to:
determine a lift axle wheel speed of at least one wheel of the lift axle;
determine a reference wheel speed of at least one reference wheel of a reference axle of the utility vehicle; and,
compare the lift axle wheel speed with the reference wheel speed; and,
wherein the lift status represents a raised lift axle when the lift axle wheel speed falls below the reference wheel speed by a wheel speed tolerance value, and represents a lowered lift axle when the lift axle wheel speed is within a wheel speed tolerance range around the reference wheel speed.

19. A method for improving the vehicle-dynamics-related stability of a utility vehicle, the utility vehicle having a steerable auxiliary axle, the method comprising:
determining a current ground speed of the utility vehicle;
determining a stability-critical speed of the utility vehicle;
comparing the current ground speed with the stability-critical speed;
determining a lock status of the steerable auxiliary axle; and,
locking the steerable auxiliary axle of the utility vehicle in straight-ahead travel, if the lock status represents a movable, currently steerable auxiliary axle and the current ground speed of the utility vehicle is greater than or equal to the stability-critical speed.
